(19) United States
(12) Patent Application Publication
(10) Pub. No.: US 2013/0067148 A1
(43) Pub. Date: Mar. 14, 2013

(54) INFORMATION PROCESSING APPARATUS AND INFORMATION PROCESSING METHOD

(71) Applicants: Yoshinori Takagi, Kanagawa (JP); Ichiro Ogata, Kanagawa (JP); Hirofumi Hibi, Kanagawa (JP); Yoshihiro Tamura, Kanagawa (JP); Daisuke Izaki, Tokyo (JP); Kyosuke Yoshida, Kanagawa (JP)

(72) Inventors: Yoshinori Takagi, Kanagawa (JP); Ichiro Ogata, Kanagawa (JP); Hirofumi Hibi, Kanagawa (JP); Yoshihiro Tamura, Kanagawa (JP); Daisuke Izaki, Tokyo (JP); Kyosuke Yoshida, Kanagawa (JP)

(73) Assignee: Sony Corporation, Tokyo (JP)

(21) Appl. No.: 13/611,658

(22) Filed: Sep. 12, 2012

(30) Foreign Application Priority Data
Sep. 14, 2011 (JP) 2011-200452

(51) Int. Cl. G06F 12/00

(52) U.S. Cl. 711/103; 711/E12.008

(57) ABSTRACT

An information processing apparatus includes an assignment unit and a determination unit. The assignment unit evaluates physical properties of each of a plurality of semiconductor memories constituting one storage device as a whole and assigns a usage attribute corresponding to an evaluation result to at least a part of the plurality of semiconductor memories. The determination unit determines a semiconductor memory having an optimal usage attribute as a write destination of data with respect to a write command of the data.

### BACKGROUND

The present disclosure relates to an information processing apparatus and an information processing method, and particularly to an information processing apparatus and an information processing method that are favorable in a case where an SSD (solid state drive) is used as a storage device.

In recent years, the SSD is attracting attention as a storage device whose capacity is easily increased, and which has a high read speed when performing random access.

For a standard SSD, a NAND flash memory is used now.

In Particular, a fact that the NAND flash memory becomes unable to hold memory information as the deterioration of memory cells progresses with the increase of the number of rewriting has been known. Specifically, as rewriting is repeated, the deterioration of a tunnel oxide film for preventing electrons from leaking from a floating gate that stores the electrons progresses, and some of the electrons leaks from the tunnel oxide film, thereby reducing the amount of the electrons in the floating gate. Moreover, examples of a unique problem of a semiconductor product include a problem of an individual difference in properties due to variability of purity between the center portion and the peripheral portion of a silicon wafer or variability of purity in a Z direction of the silicon wafer.

In this regard, the SSD employs a wear leveling which prevents a tunnel oxide film of a part of blocks from being intensively deteriorated by managing the number of writes in the unit of a block and equalizing the number of writes in all the blocks. Further, a bad block management, an error correcting function, and the like are employed. In the bad block management, a block which has failed to write due to an error is registered and the block is prohibited to be used thereafter.

Japanese Patent Application Laid-open No. 2010-061578 (paragraph [0006]) discloses a method for identifying/analyzing an expected available time (expected lifetime) of a semiconductor storage device such as the SSD. In this method, a rise coefficient based on the temporal transition of an erase count is calculated, and the expected available time of the semiconductor storage device is calculated with the use of a relationship between the rise coefficient and a maximum value of the erase count calculated from the capacity of the semiconductor storage device. That is, an elapsed time during which the erase count of the semiconductor storage device reaches the above-mentioned maximum value of the erase count according to the rise coefficient of the erase count thus calculated, in a case where a computer is continued to be used, is calculated as the expected available time, and is displayed on a display of the computer.

### SUMMARY

In the wear leveling, the lifetime of the SSD is expected to be prolonged. On the other hand, in the technique disclosed in Japanese Patent Application Laid-open No. 2010-061578, the replacing time of the SSD is managed by displaying the expected available time. Both the techniques contribute to the improvement of the reliability of a system that uses the SSD as a storage device. However, there is another problem on the responsiveness of reading and writing of data with respect to the SSD.

However, in the current situation where an individual difference in physical properties between the SSDs, which is caused due to spatial variability or the like of an impurity concentration of a silicon substrate, may be impossible to be removed, a technique for improving a total responsiveness in a case where a storage device is attained with a plurality of SSDs is not established specifically.

In view of the circumstances as described above, there is a need for an information processing apparatus and an information processing method that are capable of improving a total responsiveness in a case where a plurality of semiconductor memories are used as a storage device.

According to an embodiment of the present disclosure, there is provided an information processing apparatus including: an assignment unit configured to evaluate physical properties of each of a plurality of semiconductor memories constituting one storage device as a whole and assign a usage attribute corresponding to an evaluation result to at least a part of the plurality of semiconductor memories; and a determination unit configured to determine a semiconductor memory having an optimal usage attribute as a write destination of data with respect to a write command of the data.

In this embodiment, based on the evaluation result of the physical properties of each of the plurality of semiconductor memories constituting one storage device as a whole, a usage attribute is assigned to at least a part of the plurality of semiconductor memories by the assignment unit, and a semiconductor memory having an optimal usage attribute as a write destination of the data with respect to the write command of the data is determined by the determination unit. That is, in this embodiment, in a case where there is an individual difference in physical properties of the plurality of semiconductor memories, a write destination of the data is determined by the determination unit so as to utilize the physical properties of the semiconductor memory. Accordingly, a total responsiveness of the storage device is expected to be improved, in a case where the plurality of semiconductor memories are used as the storage device.

The information processing apparatus according to this embodiment may further include a processing unit. The processing unit may perform predetermined arithmetic processing on the data and add an attribute designation flag to the write command of the data subjected to the arithmetic processing. The determination unit may receive the write command from the processing unit and determine, based on the attribute designation flag added to the write command, the semiconductor memory having the optimal usage attribute.

Specifically, the processing unit determines that the data subjected to the arithmetic processing belongs to which one of the following data: the data, reading and writing of which are repeated frequently with respect to the storage device; the data, reading of which is repeated almost without being rewritten after being written once; and the data, update of which is repeated many times by rewriting, for example, and adds an attribute designation flag corresponding to the result to the write command. Accordingly, in the case where there is an individual difference in physical properties of the plurality of the semiconductor memories, the write destination of the data can be properly determined by the determination unit so as to utilize the physical properties of each of the semiconductor memories.

The assignment unit may be configured to evaluate the physical properties of each of the plurality of semiconductor memories for each of property evaluation criteria including at least a generation rate of a bad block, a read time, and a write time, to assign, to a part of the plurality of semiconductor memories, a usage attribute of read/write priority based on evaluation results, to assign, to another part of the plurality of semiconductor memories, a usage attribute of read priority, and to assign, to still another part of the plurality of semiconductor memories, a usage attribute of write priority. Accordingly, physical properties of the semiconductor memories can be properly evaluated, and an appropriate usage attribute can be assigned to the semiconductor memories.

The assignment unit may transfer, based on a read frequency of data of a file, the data of the file among the plurality of semiconductor memories which are assigned with different usage attributes. The data of the file can be transferred to a semiconductor memory assigned with a usage attribute suited to an actual read frequency. Accordingly, for example, such a waste of the capacity that the capacity of the semiconductor memories, which have relatively high physical properties and assigned with the usage attributes of read/write priority, read priority, and the like, is consumed by the data of the file which does not have a high read frequency actually can be removed effectively.

The assignment unit may manage, in a management table, a file name, a file creation date and time, a logical address, a physical address of each of the semiconductor memories, and the number of reads to be associated with one another, and calculate the read frequency based on the file creation date and time and a value of the number of reads registered in the management table. Accordingly, the read frequency of the data of the file can be calculated properly, and the reliability of the processing of transferring the data of the file among the plurality of the semiconductor memories assigned with different usage attributes is improved.

The assignment unit may be configured to include, as threshold values for evaluation with respect to the read frequency of the data of the file, at least a first threshold value, a second threshold value, and a third threshold value, which satisfy that the first threshold value<the second threshold value<the third threshold value, to transfer, to a first semiconductor memory of the plurality of semiconductor memories, the data of the file when the read frequency becomes greater than the third threshold value and the data of the file is in a semiconductor memory other than the first semiconductor memory, the first semiconductor memory being assigned with the usage attribute of the read/write priority, to transfer, to a second semiconductor memory of the plurality of semiconductor memories, the data of the file when the read frequency becomes greater than the second threshold value and equal to or smaller than the third threshold value, and the data of the file is in a semiconductor memory other than the second semiconductor memory, the second semiconductor memory being assigned with the usage attribute of the read priority, to transfer, to a third semiconductor memory of the plurality of semiconductor memories, the data of the file when the read frequency becomes greater than the first threshold value and equal to or smaller than the second threshold value, and the data of the file is in a semiconductor memory other than the third semiconductor memory, the third semiconductor memory being assigned with the usage attribute of the write priority, and to transfer, to a fourth semiconductor memory of the plurality of semiconductor memories, the data of the file when the read frequency is equal to or smaller than the first threshold value, and the data of the file is in a semiconductor memory other than the fourth semiconductor memory, the fourth semiconductor memory being assigned with no usage attribute.

Accordingly, such a waste of the capacity that the capacity of the semiconductor memories such as the first semiconductor memory and the second semiconductor memory, which have relatively high physical properties, is consumed by the data of the file which does not have a high read frequency actually can be removed effectively. Conversely, the data of the file which has a high read frequency actually can be prevented from being kept stored in the semiconductor memories such as the third semiconductor memory and the fourth semiconductor memory, which have relatively low physical properties. Accordingly, the apparent responsiveness of the storage device can be improved.

Moreover, the assignment unit may transfer, based on a read frequency of data of a file and an elapsed time from a previous read, the data of the file among the plurality of semiconductor memories which are assigned with different usage attributes.

The assignment unit may manage, in a management table, a file name, a file creation date and time, a logical address, a physical address of each of the semiconductor memories, the number of reads, and the latest read time to be associated with one another, and calculate the read frequency and the elapsed time based on the file creation date and time, a value of the number of reads, and the latest read time registered in the management table.

The assignment unit may be configured to include, as threshold values for evaluation with respect to the read frequency of the data of the file, a first read frequency threshold value and a second read frequency threshold value, which satisfy that the first read frequency threshold value>the second read frequency threshold value, and as threshold values for the elapsed time from the previous read, a first elapsed time threshold value and a second elapsed time threshold value, which satisfy that the first elapsed time threshold value<the second elapsed time threshold value, to transfer, to a semiconductor memory having a higher order than a semiconductor memory storing the data of the file, the data of the file when the read frequency becomes greater than the first read frequency threshold value and the elapsed time is shorter than the first elapsed time threshold value, according to a predetermined order between a first semiconductor memory, a second semiconductor memory, a third semiconductor memory, and a fourth semiconductor memory that are included in the plurality of semiconductor memories, the first semiconductor memory being assigned with the usage attribute of the read/write priority, the second semiconductor memory being assigned with the usage attribute of the read priority, the third semiconductor memory being assigned with the usage attribute of the write priority, the fourth semiconductor memory being assigned with no usage attribute, and to transfer, to the fourth semiconductor memory, the data of the file when the read frequency is smaller than the second read frequency threshold value and the elapsed time is longer than the second elapsed time threshold value.

An information processing method according to another embodiment of the present disclosure includes: evaluating, by an assignment unit, physical properties of each of a plurality of semiconductor memories constituting one storage device as a whole and assigning a usage attribute corresponding to an evaluation result to at least a part of the plurality of semiconductor memories; and determining, by a determination unit, a semiconductor memory having an optimal usage attribute as a write destination of data with respect to a write command of the data.

According to the embodiments of the present disclosure, a total responsiveness of a storage device is expected to be improved, in the case where the plurality of semiconductor memories are used as the storage device.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a functional configuration of an information processing apparatus according to a first embodiment of the present sure;

FIG. 2 is a flowchart showing a flow of processing by a usage attribute assignment unit in the information processing apparatus of FIG. 1;

FIG. 3 is an example of an assignment result of an optimal usage corresponding to an estimation result for each of property evaluation criteria;

FIG. 4 is a flowchart showing an operation of a dispatcher unit when writing a file in the information processing apparatus of FIG. 1;

FIG. 5 is a diagram showing a configuration of a management table stored in an SSD;

FIG. 6 is a flowchart showing an operation of the dispatcher unit when reading the file in the information processing apparatus of FIG. 1;

FIG. 7 is a flowchart showing file transfer processing among usage attribute SSDs based on a read frequency by the usage attribute assignment unit in the information processing apparatus of FIG. 1; and

FIG. 8 is a flowchart showing file transfer processing among usage attribute SSDs based on a read frequency by a usage attribute assignment unit in an information processing apparatus according to a second embodiment of the present disclosure.

### DETAILED DESCRIPTION OF EMBODIMENTS

Hereinafter, embodiments according to the present disclosure will be described with reference to the drawings.

### First Embodiment

### Functional Configuration of Information Processing Apparatus

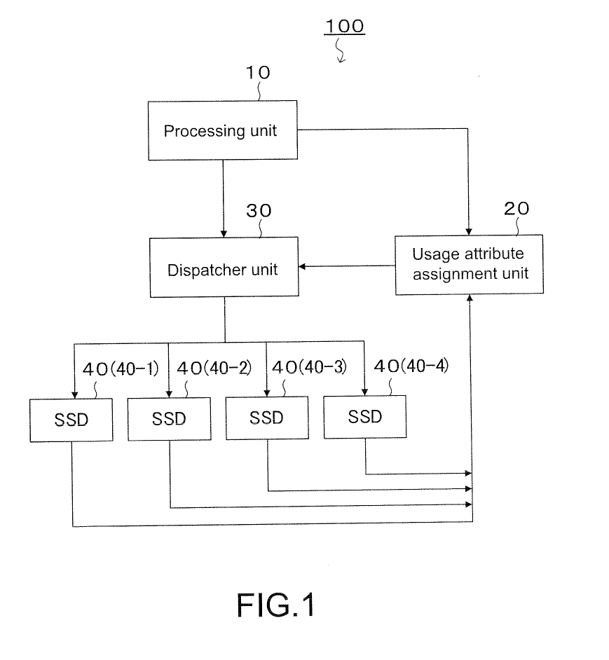

FIG. 1 is a block diagram showing a functional configuration of an information processing apparatus according to a first embodiment of the present disclosure.

An information processing apparatus 100 according to this embodiment includes a processing unit 10, a usage attribute assignment unit 20 (assignment unit), a dispatcher unit 30 (determination unit), and a plurality of SSDs 40 (semiconductor memories).

Here, the plurality of SSDs 40 (SSD 40-1, 40-2, 40-3, and 40-4) constitute a storage device as a whole. Each of the SSDs 40 is a semiconductor memory device on which a NAND flash memory is mounted as a storage element, for example. In terms of hardware, each of the SSDs 40 is constituted of a plurality of flash memory chips and a controller which controls the reading/writing of data with respect to the flash memory chips. The controller is controlled by an OS (Operating System) incorporated in the information processing apparatus 100 using a device driver that is software for controlling the controller in the SSDs 40. It should be noted that, in this embodiment, the number of SSDs 40 is 4 in FIG. 1, but is not limited thereto. The number of SSDs 40 only needs to be at least two.

In terms of hardware, the processing unit 10 is constituted of a CPU (Central Processing Unit), a main memory, and the like of the information processing apparatus 100. The processing unit 10 can perform predetermined arithmetic processing on data according to an application program under the OS and write, to the storage, the data subjected to the arithmetic processing. The processing unit 10 can also read data from the storage, perform arithmetic processing again on the data, and write again, to the storage, the data thus obtained. Further, the processing unit 10 can add, to a write command, an attribute designation flag which is a flag designating a usage attribute of an SSD 40 of a write destination according to the type or object of the data subjected to the arithmetic processing.

The usage attribute assignment unit 20 can evaluate physical properties of each of the SSDs 40 and assign, to each of the SSDs 40, a usage attribute corresponding to the physical properties. The usage attribute assignment unit 20 also can calculate a read frequency of data of a file and transfer the data of the file among the plurality of SSDs 40 which have different usage attributes.

The dispatcher unit 30 determines an SSD 40 having an optimal usage attribute as a write destination of data with respect to a write command of the data from the processing unit 10 and supplies the write command to the SSD 40.

The usage attribute assignment unit 20 and the dispatcher unit 30 are, specifically, a program module such as a device driver for SSD, for example. In other words, the program module causes computer resources such as the CPU and the main memory in the information processing apparatus 100 to operate as the usage attribute assignment unit 20 and the dispatcher unit 30.

Next, the functions of the usage attribute assignment unit 20 and the dispatcher unit 30 will be described in detail.

### Usage Attribute Assignment Unit 20

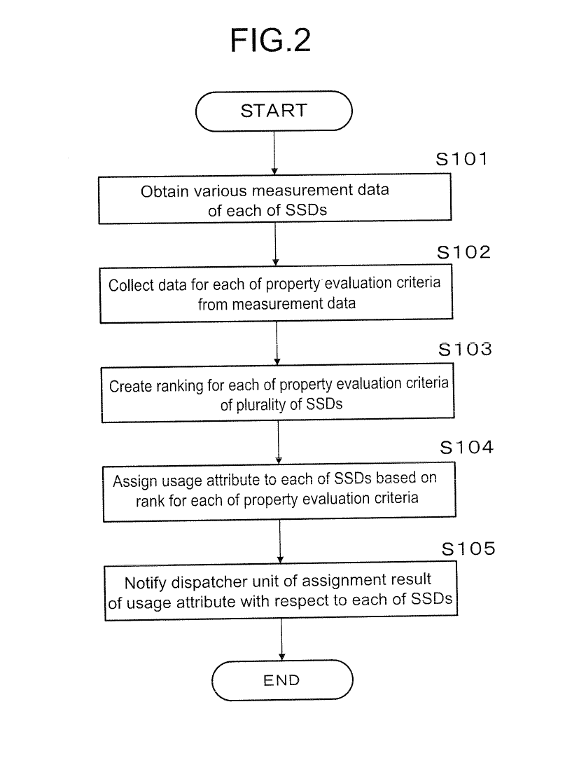

FIG. 2 is a flowchart showing a flow of processing by the usage attribute assignment unit 20.

The usage attribute assignment unit 20 obtains various measurement data such as the number of processing times, the number of the generation of bad blocks, a read time, and a write time, which are obtained by a self-monitoring analysis and reporting technology (S.M.A.R.T.) of the SSDs 40, for example (step S101).

Next, the usage attribute assignment unit 20 collects, from the measurement data thus obtained, data for each of property evaluation criteria of the SSDs 40 (step S102). Examples of the property evaluation criteria of the SSDs 40 are as follows.

1. Generation rate of bad block
2. Read time
3. Write time

Specifically, the usage attribute assignment unit 20 calculates the generation rate of the bad blocks by dividing the number of generation of the bad blocks by the number of processing times. The read time as the property evaluation criteria, more specifically includes an average value, a median value, an RMS (Root Mean Square), and the like of the read time. The write time as the property evaluation criteria more specifically includes an average value, a median value, an RMS, and the like of the write time.

Next, the usage attribute assignment unit 20 creates, based on the collected data for each of the property evaluation criteria, a ranking for each of the property evaluation criteria of the plurality of SSDs 40 under the following rule, for example (step S103).

A. A high rank (rank of read/write priority) of the property evaluation criteria of a generation rate of bad blocks is provided to the SSDs in ascending order of the generation rate of the bad blocks.
B. A high rank of the property evaluation criteria of the read time is provided to the SSDs in ascending order of the read time.
C. A high rank of the property evaluation criteria of the write time is provided to the SSDs in ascending order of the write time.
D. The highest rank of each of the plurality of the property evaluation criteria is provided to a different SSD 40 based on a priority relationship among the predetermined property evaluation criteria to prevent only a certain SSD 40 from being provided with the highest rank of the plurality of the property evaluation criteria. In the priority relationship among the property evaluation criteria, for example, the generation rate of the bad blocks, the read time, and the write time are prioritized in the stated order.

The rule for the ranking for each of the property evaluation criteria is not limited to the above-mentioned rule.

The usage attribute assignment unit 20 assigns, to each of the SSDs 40, a usage attribute corresponding to the physical properties of each SSD 40, based on the rank for each of the property evaluation criteria (Step S104).

Examples of the usage attribute are as follows, for example.

a. Read/write priority
b. Read priority
c. Write priority
d. No attribute
Hereinafter, the read/write priority is referred to as “R/W priority”, the read priority is referred to as “R priority”, and the write priority is referred to as “W priority”.

The usage attribute assignment unit 20 assigns, to the SSD 40 provided with the highest rank of the property evaluation criteria of the generation rate of the bad blocks, the usage attribute of the R/W priority. The SSD 40 assigned with the usage attribute of the R/W priority is referred to as “R/W priority SSD”.

The usage attribute assignment unit 20 assigns, to the SSD 40 provided with the highest rank of the property evaluation criteria of the read time, the usage attribute of the R priority. The SSD 40 assigned with the usage attribute of the R priority is referred to as “R priority SSD”.

The usage attribute assignment unit 20 assigns, to the SSD 40 provided with the highest rank of the property evaluation criteria of the write time, the usage attribute of the W priority. The SSD 40 assigned with the usage attribute of the W priority is referred to as “W priority SSD”.

The SSD 40 to which any usage attribute of the R/W priority, the R priority, and the W priority is not assigned is referred to as “no attribute SSD”.

The usage attributes are assigned to each of the SSDs as described above, and the assignment result is notified to the dispatcher unit 30 (step S105).

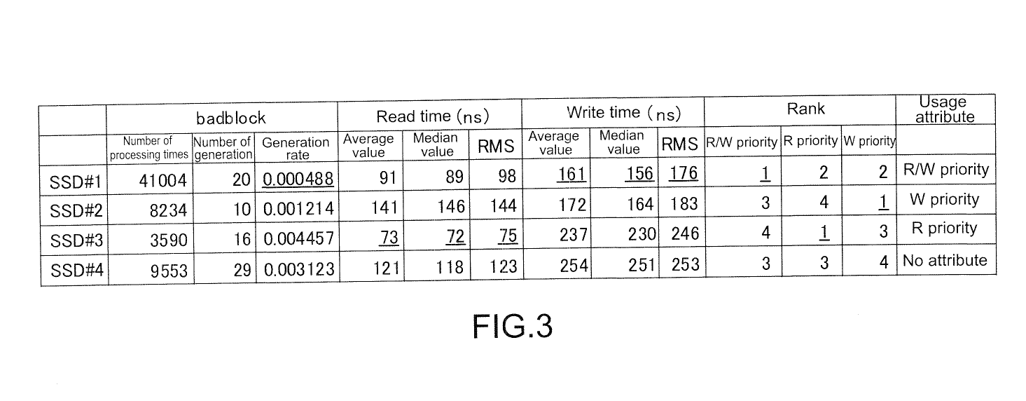

FIG. 3 is an example of an assignment result of an optimal usage corresponding to an estimation result for each of property evaluation criteria.

Here, SSD #1, SSD #2, SSD #3, and SSD #4 are four SSDs 40 to be evaluated. In the priority relationship among the property evaluation criteria, in this embodiment, the generation rate of the bad blocks, the read time, and the write time are prioritized in the stated order. It should be noted that the present disclosure is not limited thereto.

The generation rate of the bad blocks of the SSD #1 is smallest in the four SSDs #1, #2, #3, and #4. The read time of the SSD #3 is shortest. Although the write time of the SSD #1 is shortest, the highest rank of the property evaluation criteria of the write time is provided to the SSD #2 which has the shortest write time subsequent to the SSD #1 because the SSD #1 is already provided with the highest rank of property evaluation criteria of the generation rate of the bad blocks.

As a result, the usage attributes are eventually assigned as follows.

SSD #1=R/W priority SSD
SSD #2=W priority SSD
SSD #3=R priority SSD
SSD #4=No attribute SSD

The assignment of the usage attributes as described above is started regularly, e.g., once a week, and automatically or manually at the time when the load is low such as a timing when a request from a user is not generated for a certain time or more. Then, the assignment of the usage attributes is updated based on the evaluation result for each of the latest property evaluation criteria which is newly obtained.

### Addition of Attribute Designation Flag to Write Command by Processing Unit 10

When writing data to the SSD 40, the processing unit 10 can add, to the write command, an attribute designation flag which designates a usage attribute of the write destination of the data based on an application. The processing unit 10 determines the attribute designation flag to be added under the following rules, for example.

1. The attribute designation flag of the R/W priority is added to a write command of a file, reading and writing of which are repeated frequently with respect to the storage, such as a write command when a part of a storage area of the SSD 40 is used as a virtual main memory area (swap area) used by the OS.

2. The attribute designation flag of the R priority is added to a write command of a file, reading of which is repeated many times almost without being rewritten after being written once. For example, in the field of video editing, a file itself of a video source taken by a camera is rarely updated after the file is stored in the storage once, although the file is read partially and editing of the file is repeated. Therefore, the attribute designation flag of the R priority is added to the write command of the file of the video source taken by the camera.

3. The attribute designation flag of the W priority is added to a write command of a file, an update of which is repeated many times by rewriting. For example, in the field of the video editing, a user as an editor repeats reading a file from the R priority SSD 40 or the like to start editing of video data and writing the file being edited to the W priority SSD 40 until the editing is completed. Therefore, the attribute designation flag of W priority is added to the write command of the file being edited.

4. For example, no attribute designation flag is added to a write command of a file, for which it may be impossible to know in advance which of reading and writing is performed more. In many fields other than the video editing, a lot of files are applied to this case. In this case, it is possible to add no attribute designation flag to all the write commands other than the write command with respect to the swap area.

### Dispatcher Unit 30

Next, the dispatcher unit 30 will be described in detail.

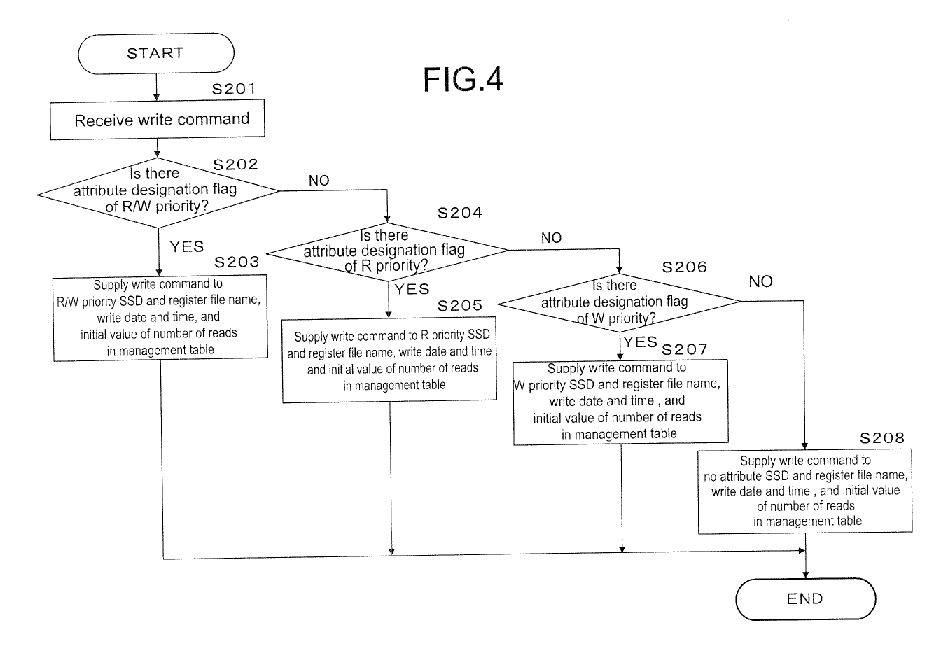

FIG. 4 is a flowchart showing an operation of the dispatcher unit 30 when writing the file.

To write the data of the file to the SSD 40, the processing unit 10 accesses a file system and obtains a logical address corresponding to a capacity of free space in logical memory space. Then, the processing unit 10 supplies, to the dispatcher unit 30, information on the logical address and the write command.

When receiving the information on the logical address and the write command from the processing unit 10 (step S201), the dispatcher unit 30 checks whether there is an attribute designation flag which may be added to the write command. When the write command is added with the attribute designation flag of the R/W priority (YES in step S202), the dispatcher unit 30 determines the R/W priority SSD as the write destination. The dispatcher unit 30 supplies, to the R/W priority SSD, the information on the logical address and the write command supplied from the processing unit 10.

The R/W priority SSD assigns, to the logical address thus obtained, a physical address of free space of its own and writes, to the physical address, the data of the file. Here, the physical address is a physical address in the entire physical address space of a plurality of SSDs. The dispatcher unit 30 registers, in a management table in the R/W priority SSD, a file name, a file creation date and time, a logical address, a physical address, and an initial value of the number of reads, of the file written to the R/W priority SSD, by associating them with one another (step S203). The initial value of the number of reads is “0”.

It should be noted that the management table is stored in the R/W priority SSD because reading and writing are performed relatively frequently.

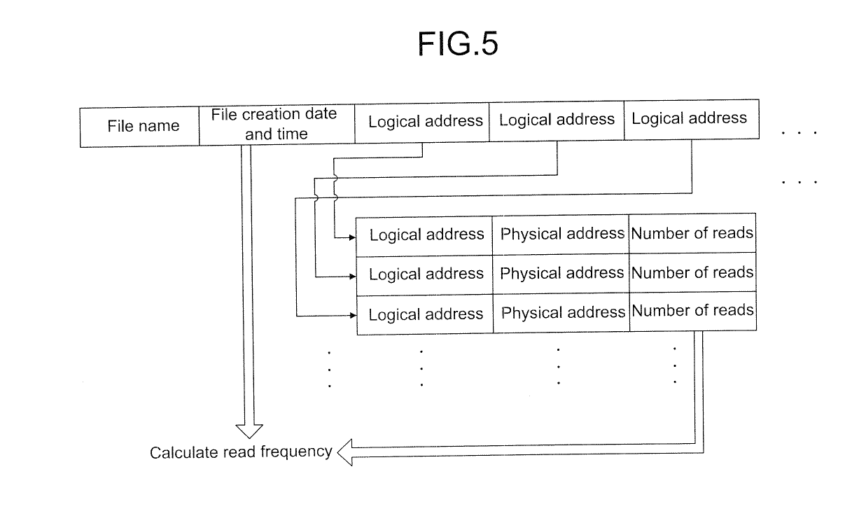

FIG. 5 is a diagram showing a configuration of the management table.

As shown in the figure, in the management table, the file name, the file creation date and time (write date and time), one or more logical addresses are registered by being associated with one another for each of the files stored in the SSDs 40. Further, in the management table, the physical address and the number of reads are registered by being associated with one another for each of the logical addresses.

Incidentally, in the semiconductor memory such as the SSD, during updating of the stored file, all data of the file before updating is deleted and the updated file is written to a newly determined address. Therefore, the number of reads and the file creation date and time (write date and time) can be used as information for obtaining the read frequency of the file. The information for obtaining the read frequency of the file is used for processing of transferring the files among the usage attribute SSDs based on the read frequency, which will be described later.

Now, return to the description of the operation of the dispatcher unit 30 when writing the file.

The dispatcher unit 30 determines, when the write command received from the processing unit 10 is added with the attribute designation flag of the R priority (YES in step S204), the R priority SSD as the write destination. The dispatcher unit 30 supplies, to the R priority SSD, the information on the logical address and the write command supplied from the processing unit 10.

The R priority SSD assigns, to the logical address thus obtained, a physical address of free space of its own and writes, to the physical address, the data of the file. The dispatcher unit 30 registers, in the management table in the R/W priority SSD, the file name, the file creation date and time, the logical address, the physical address, and the initial value of the number of reads, of the file written to the R priority SSD, by associating them with one another (step S205).

Further, the dispatcher unit 30 determines, when the write command of the file received from the processing unit 10 is added with the attribute designation flag of the W priority (YES in step S206), the W priority SSD as the write destination. The dispatcher unit 30 supplies, to the W priority SSD, the information on the logical address and the write command supplied from the processing unit 10.

The W priority SSD assigns, to the logical address thus obtained, a physical address of free space of its own and writes, to the physical address, the data of the file. The dispatcher unit 30 registers, in the management table in the R/W priority SSD, the file name, the file creation date and time, the logical address, the physical address, and the initial value of the number of reads, of the file written to the W priority SSD, by associating them with one another (step S207).

Further, the dispatcher unit 30 determines, when the write command of the file received from the processing unit 10 is not added with the attribute designation flag (No in step S206), the no attribute SSD as the write destination. The dispatcher unit 30 supplies, to the no attribute SSD, the information on the logical address and the write command supplied from the processing unit 10.

The no attribute SSD assigns, to the logical address thus obtained, a physical address of free space of its own and write, to the physical address, the data of the file. The dispatcher unit 30 registers, in the management table in the R/W priority SSD, the file name, the file creation date and time, the logical address, the physical address, and the initial value of the number of reads, of the file written to the no attribute SSD, by associating them with one another (step S208).

These are the operations of the dispatcher unit 30 when writing the file.

### Operation when Reading

Next, an operation when reading will be described.

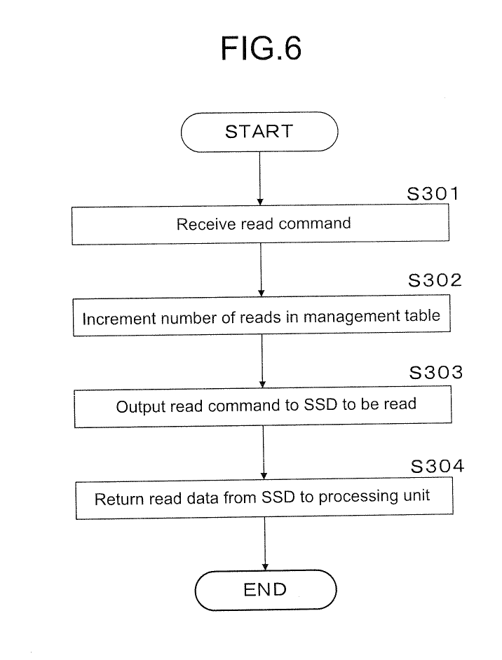

FIG. 6 is a flowchart showing an operation of the dispatcher unit 30 when reading the file.

The processing unit 10 accesses the file system and obtains information on the logical address corresponding to the file name to be read. Then, the processing unit 10 supplies, to the dispatcher unit 30, the information on the logical address thus obtained and a read command.

When receiving the information on the logical address and the read command from the processing unit 10 (step S301), the dispatcher unit 30 converts the logical address into the physical address with reference to the management table and increments a value of the number of reads associated with the physical address (step S302).

The dispatcher unit 30 determines, based on the physical address, an SSD 40 to be read and outputs, to the SSD 40, the information on the physical address and the read command (step S303). The SSD 40 to be read reads, based on the information on the physical address and the read command supplied from the dispatcher unit 30, the data from the physical address and returns the data to the processing unit 10 (step S304).

As described above, the dispatcher unit 30 increments, every time the file is read from the SSD 40, the number of reads associated with the physical address to which the data of the file is written. Each of the information on the number of reads and the information on the file creation date and time is used as information for calculating the read frequency of the file.

### File Transfer Among Usage Attribute SSDs Based on Read Frequency

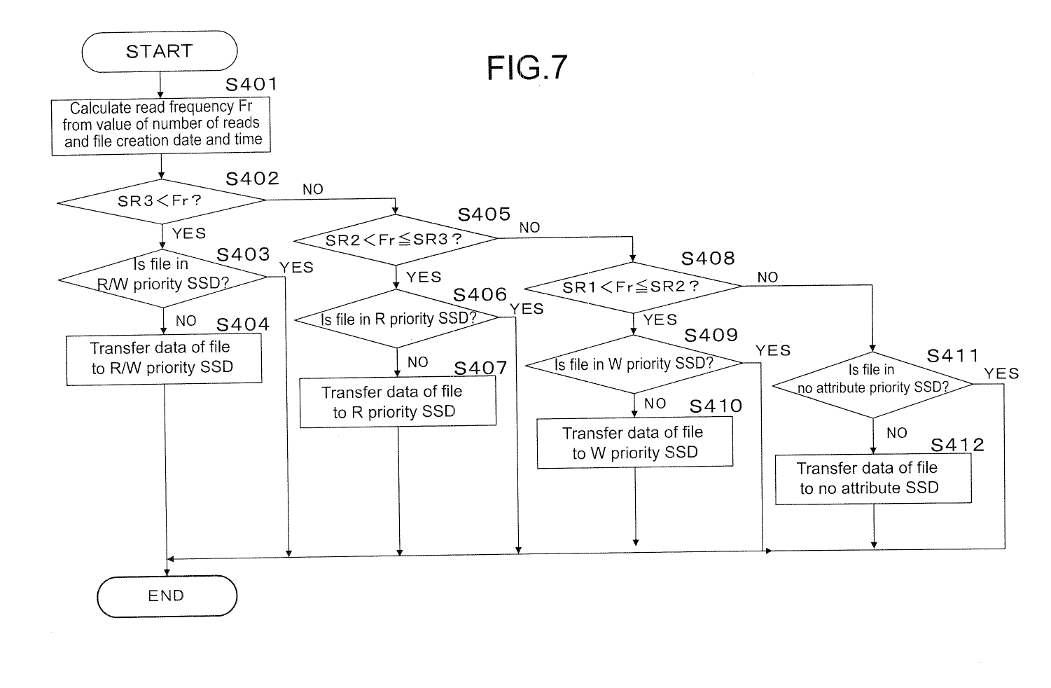

FIG. 7 is a flowchart showing file transfer processing among the usage attribute SSDs based on the read frequency by the usage attribute assignment unit 20.

The processing is started regularly, e.g., once a day or once a week, and automatically or manually at the time when the load is low such as a timing when a request from a user is not generated for a certain time or more.

When the processing is started, the usage attribute assignment unit 20 reads the value of the number of reads and the file creation date and time (write date and time) for each of the files with reference to the management table and calculates a read frequency Fr of the file (step S401). The read frequency Fr is obtained by dividing the value of the number of reads by an elapsed time from the file creation date and time to the current date and time.

The usage attribute assignment unit 20 includes a plurality of threshold values SR1, SR2, and SR3 with respect to the read frequency of the file. The relationship between the threshold values satisfies the expression, SR1<SR2<SR3.

When the read frequency of the file becomes greater than the SR3 (YES in step S402) and the data of the file is in the SSD 40 other than the R/W priority SSD (NO in step S403), the usage attribute assignment unit 20 transfers, to the R/W priority SSD, the data of the file (step S404). When the data of the file is in the R/W priority SSD (YES in step S403), the usage attribute assignment unit 20 does nothing.

When the read frequency of each of the files becomes greater than the SR2 and equal to or smaller than SR3 (YES in step S405) and the data of the file is in the SSD 40 other than the R priority SSD (NO in step S406), the usage attribute assignment unit 20 transfers, to the R priority SSD, the data of the file (step S407). When the data of the file is in the R priority SSD (YES in step S406), the usage attribute assignment unit 20 does nothing.

When the read frequency of each of the files becomes greater than the SR1 and equal to or smaller than SR2 (YES in step S408) and the data of the file is in the SSD 40 other than the W priority SSD (NO step S409), the usage attribute assignment unit 20 transfers, to the W priority SSD, the data of the file (step S410). When the data of the file is in the W priority SSD (YES in step S409), the usage attribute assignment unit 20 does nothing.

When the read frequency of each of the files is equal to or smaller than the SR1 (NO in step S408) and the data of the file is in the SSD 40 other than the no attribute SSD (NO in step S411), the usage attribute assignment unit 20 transfers, to the no attribute SSD, the data of the file (step S412). When the data of the file is in the no attribute SSD (YES in step S411), the usage attribute assignment unit 20 does nothing.

It should be noted that, in a case where the SSD 40 of the transfer destination does not have sufficient free space when the data of the file is transferred to the SSD having another usage attribute, the usage attribute assignment unit 20 successively tries to transfer the data of the file to the SSD having a lower usage attribute than the transfer destination according to a predetermined order between the R/W priority SSD, the R priority SSD, the W priority SSD, and the no attribute SSD.

As described above, the data of the file can be transferred to the SSD 40 having the usage attribute suited to the actual read frequency. Accordingly, such a waste of the capacity that the capacity of the SSDs 40 such as the R/W priority SSD and the R priority SSD, which have relatively high physical properties, is consumed by the data of the file which does not have a high read frequency actually can be removed effectively, for example. Conversely, the data of the file which has a high read frequency actually can be prevented from being kept stored in the SSDs 40 such as the W priority SSD and the no attribute SSD, which have relatively low physical properties. Accordingly, the apparent responsiveness of the storage device can be improved.

### Second Embodiment

In the first embodiment, the processing of transferring the data of the file to the SSD having another usage attribute is performed based on the read frequency for each of the files. However, the present disclosure is not limited thereto.

For example, not only the read frequency for each of the files but also an elapsed time from the previous read may be used to transfer the file among the usage attribute SSDs.

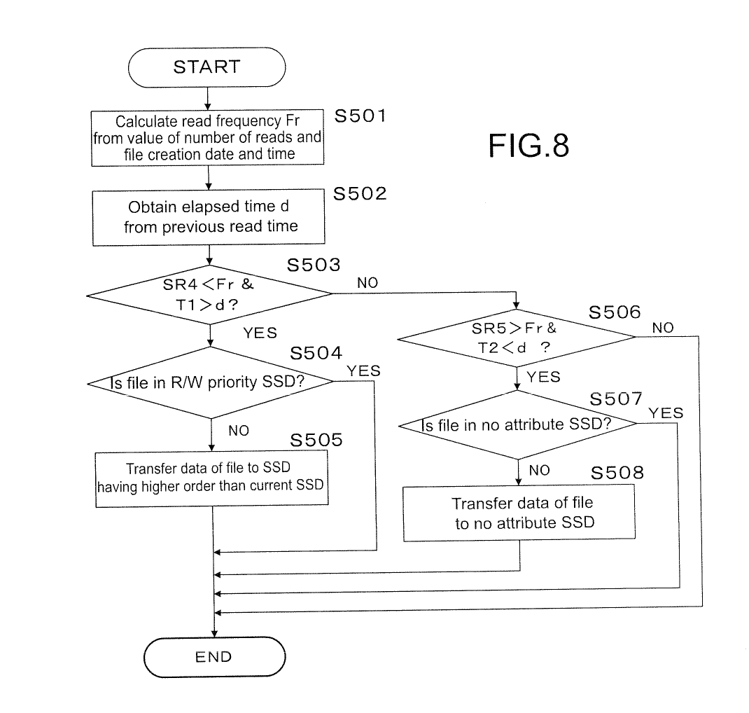

FIG. 8 is a flowchart showing an example of file transfer processing among the usage attribute SSDs based on the read frequency for each of the files and the elapsed time from the previous read.

The processing is started regularly, e.g., once a day or once a week, and automatically or manually at the time when the load is low such as the timing when a request from a user is not generated for a certain time or more. Alternatively, the processing may be performed every time the request for read of the file is generated. In this case, it is desirable to perform the processing after the data of the file is read in order to balance the load in terms of time.

When the processing is started, the usage attribute assignment unit 20 reads the value of the number of reads and the file creation date and time (write date and time) for each of the files with reference to the management table and calculates the read frequency Fr of the file (step S501). The read frequency Fr is obtained by dividing the value of the number of reads by the elapsed time from the file creation date and time to the current date and time.

Next, the usage attribute assignment unit 20 obtains an elapsed time d from the previous read time to the current time (step S502). The current time may be a starting time of the file transfer processing or a generation time of a new read request.

The usage attribute assignment unit 20 includes a plurality of threshold values SR4 and SR5 with respect to the read frequency of the file. The relationship between the threshold values SR4 and SR5 satisfies the expression, SR4>SR5. Further, the usage attribute assignment unit 20 includes a plurality of threshold values T1 and T2 with respect to the elapsed time d. The relationship between the threshold values T1 and T2 satisfies the expression, T1<T2.

When the read frequency Fr of the file becomes greater than the SR4 and the elapsed time d is shorter than the T1 (YES in step S503) and the data of the file is in the SSD other than the R/W priority SSD (NO in step S504), the usage attribute assignment unit 20 transfers, to the SSD having a higher order than the current SSD, the data of the file according to an order of the R/W priority SSD, the R priority SSD, the W priority SSD and the no attribute SSD (step S505). Here, the SSD having a higher order than the current SSD is, for example, an SSD having the next higher order or an order a predetermined number higher than the current SSD. When the data of the file is in the R/W priority SSD (YES in step S504), the transfer processing of the data of the file is not performed.

When the read frequency Fr of the file is smaller than the SR5 and the elapsed time d is longer than the T2 (YES in step S506) and the data of the file is in the SSD other than the no attribute SSD (NO in step S507), the usage attribute assignment unit 20 transfers, to the no attribute SSD, the data of the file (step S508). When the data of the file is in the no attribute SSD (YES in step S507), the transfer processing of the data of the file is not performed.

When the read frequency Fr of the file is equal to or smaller than the SR4 and the elapsed time d is equal to or longer than the threshold value T1 (NO in step S503) and the read frequency Fr of the file is equal to or greater than the SR5 and the elapsed time d is equal to or shorter than the threshold value T2 (NO in step S506), the usage attribute assignment unit 20 does not perform the transfer processing of the data of the file.

It should be noted that, in a case where the SSD of the transfer destination does not have sufficient free space when the data of the file is transferred to the SSD having another usage attribute, the usage attribute assignment unit 20 successively tries to transfer the data of the file to the SSD having a higher or lower usage attribute than the transfer destination according to a predetermined order between the R/W priority SSD, the R priority SSD, the W priority SSD, and the no attribute SSD.

As described above, the data of the file can be transferred to the SSD 40 having a usage attribute suited to the actual read frequency and the elapsed time from the previous read. Accordingly, such a waste of the capacity that the capacity of the SSDs 40 such as the R/W priority SSD and the R priority SSD, which have relatively high physical properties, is consumed by the data of the file which does not have a high read frequency and has the long elapsed time from previous read actually can be removed effectively, for example. Conversely, the data of the file which has a high read frequency actually can be prevented from being kept stored in the SSDs 40 such as the W priority SSD and the no attribute SSD, which have relatively low physical properties. Accordingly, the apparent responsiveness of the storage device can be improved.

### Modified Example 1

In the above-mentioned embodiments, the read frequency and the like of the file are calculated and the data of the entire file is transferred among the SSDs 40. As a modified example, the usage attribute assignment unit 20 may manage the read frequency for each of data parts sectioned by the physical address, and a part having a high read frequency and parts other than the former part in data of one file may be distributed to SSDs 40 having different usage attributes to be stored.

### Modified Example 2

In the above-mentioned embodiments, the physical properties are evaluated in the unit of SSD 40, and the SSD 40 is assigned with a usage attribute representing an optimal usage attribute corresponding to the physical properties thereof. The physical properties of the SSD 40 can be said to be a combined value of the physical properties of a plurality of flash memory chips to be mounted in the SSD 40. Here, if history information including the measurement data such as the number of the generation of the bad blocks, the read time, and the write time for each of the flash memory chips can be obtained, the usage attribute assignment unit 20 can set the rank for each of the property evaluation criteria in the unit of the flash memory chip in one SSD and assign the usage attribute in the unit of the flash memory chip.

### Modified Example 3

Although a case where the SSD to which the NAND flash memory is mounted is used is described above, the present disclosure can be applied to an SSD to which a semiconductor memory other than the NAND flash memory is mounted. Moreover, the present disclosure can be applied to any storage device other than the SSD, as long as it is the storage device to which the semiconductor memory is mounted.

### Modified Example 4

As a modified example relating to the file transfer among the usage attribute SSDs, in reproduction of video data, a method of transferring, from one SSD to the R priority SSD, for example, the video data located at a position a few minutes ahead of a position being reproduced can be considered. According to the method, in the real-time reproduction along with reading from the SSD, there is an advantage that the disturbance of the video being reproduced that is caused due to a delay of read can be suppressed to a minimum.

It should be noted that the present disclosure may also employ the following configurations.

(1) An information processing apparatus, including:

an assignment unit configured to evaluate physical properties of each of a plurality of semiconductor memories constituting one storage device as a whole and assign a usage attribute corresponding to an evaluation result to at least a part of the plurality of semiconductor memories; and

a determination unit configured to determine a semiconductor memory having an optimal usage attribute as a write destination of data with respect to a write command of the data.

(2) The information processing apparatus according to (1), further including

a processing unit configured to perform predetermined arithmetic processing on the data and add an attribute designation flag to the write command of the data subjected to the arithmetic processing, in which

the determination unit receives the write command from the processing unit and determine, based on the attribute designation flag added to the write command, the semiconductor memory having the optimal usage attribute.

(3) The information processing apparatus according to (1) or (2), in which

the assignment unit is configured
to evaluate the physical properties of each of the plurality of semiconductor memories for each of property evaluation criteria including at least a generation rate of a bad block, a read time, and a write time,
to assign, to a part of the plurality of semiconductor memories, a usage attribute of read/write priority based on evaluation results,
to assign, to another part of the plurality of semiconductor memories, a usage attribute of read priority, and
to assign, to still another part of the plurality of semiconductor memories, a usage attribute of write priority.

(4) The information processing apparatus according to any one of (1) to (3), in which

the assignment unit transfers, based on a read frequency of data of a file, the data of the file among the plurality of semiconductor memories which are assigned with different usage attributes.

(5) The information processing apparatus according to (4), in which

the assignment unit manages, in a management table, a file name, a file creation date and time, a logical address, a physical address of each of the semiconductor memories, and the number of reads to be associated with one another, and calculates the read frequency based on the file creation date and time and a value of the number of reads registered in the management table.

(6) The information processing apparatus according to (4) or (5), in which

the assignment unit is configured
to include, as threshold values for evaluation with respect to the read frequency of the data of the file, at least a first threshold value, a second threshold value, and a third threshold value, which satisfy that the first threshold value<the second threshold value<the third threshold value,
to transfer, to a first semiconductor memory of the plurality of semiconductor memories, the data of the file when the read frequency becomes greater than the third threshold value and the data of the file is in a semiconductor memory other than the first semiconductor memory, the first semiconductor memory being assigned with the usage attribute of the read/write priority,
to transfer, to a second semiconductor memory of the plurality of semiconductor memories, the data of the file when the read frequency becomes greater than the second threshold value and equal to or smaller than the third threshold value, and the data of the file is in a semiconductor memory other than the second semiconductor memory, the second semiconductor memory being assigned with the usage attribute of the read priority,
to transfer, to a third semiconductor memory of the plurality of semiconductor memories, the data of the file when the read frequency becomes greater than the first threshold value and equal to or smaller than the second threshold value, and the data of the file is in a semiconductor memory other than the third semiconductor memory, the third semiconductor memory being assigned with the usage attribute of the write priority, and
to transfer, to a fourth semiconductor memory of the plurality of semiconductor memories, the data of the file when the read frequency is equal to or smaller than the first threshold value, and the data of the file is in a semiconductor memory other than the fourth semiconductor memory, the fourth semiconductor memory being assigned with no usage attribute.

(7) The information processing apparatus according to any one of (1) to (3), in which

the assignment unit transfers, based on a read frequency of data of a file and an elapsed time from a previous read, the data of the file among the plurality of semiconductor memories which are assigned with different usage attributes.

(8) The information processing apparatus according to (7), in which

the assignment unit manages, in a management table, a file name, a file creation date and time, a logical address, a physical address of each of the semiconductor memories, the number of reads, and the latest read time to be associated with one another, and calculates the read frequency and the elapsed time based on the file creation date and time, a value of the number of reads, and the latest read time registered in the management table.

(9) The information processing apparatus according to (7) or (8), in which

the assignment unit is configured
to include, as threshold values for evaluation with respect to the read frequency of the data of the file, a first read frequency threshold value and a second read frequency threshold value, which satisfy that the first read frequency threshold value>the second read frequency threshold value, and as threshold values for the elapsed time from the previous read, a first elapsed time threshold value and a second elapsed time threshold value, which satisfy that the first elapsed time threshold value<the second elapsed time threshold value,
to transfer, to a semiconductor memory having a higher order than a semiconductor memory storing the data of the file, the data of the file when the read frequency becomes greater than the first read frequency threshold value and the elapsed time is shorter than the first elapsed time threshold value, according to a predetermined order between a first semiconductor memory, a second semiconductor memory, a third semiconductor memory, and a fourth semiconductor memory that are included in the plurality of semiconductor memories, the first semiconductor memory being assigned with the usage attribute of the read/write priority, the second semiconductor memory being assigned with the usage attribute of the read priority, the third semiconductor memory being assigned with the usage attribute of the write priority, the fourth semiconductor memory being assigned with no usage attribute, and
to transfer, to the fourth semiconductor memory, the data of the file when the read frequency is smaller than the second read frequency threshold value and the elapsed time is longer than the second elapsed time threshold value.

The present disclosure contains subject matter related to that disclosed in Japanese Priority Patent Application JP 2011-200452 filed in the Japan Patent Office on Sep. 14, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
an assignment unit configured to evaluate physical properties of each of a plurality of semiconductor memories constituting one storage device as a whole and assign a usage attribute corresponding to an evaluation result to at least a part of the plurality of semiconductor memories; and
a determination unit configured to determine a semiconductor memory having an optimal usage attribute as a write destination of data with respect to a write command of the data.

2. The information processing apparatus according to claim 1, further comprising
a processing unit configured to perform predetermined arithmetic processing on the data and add an attribute designation flag to the write command of the data subjected to the arithmetic processing, wherein
the determination unit receives the write command from the processing unit and determine, based on the attribute designation flag added to the write command, the semiconductor memory having the optimal usage attribute.

3. The information processing apparatus according to claim 2, wherein
the assignment unit is configured
to evaluate the physical properties of each of the plurality of semiconductor memories for each of property evaluation criteria including at least a generation rate of a bad block, a read time, and a write time,
to assign, to a part of the plurality of semiconductor memories, a usage attribute of read/write priority based on evaluation results,
to assign, to another part of the plurality of semiconductor memories, a usage attribute of read priority, and
to assign, to still another part of the plurality of semiconductor memories, a usage attribute of write priority.

4. The information processing apparatus according to claim 3, wherein
the assignment unit transfers, based on a read frequency of data of a file, the data of the file among the plurality of semiconductor memories which are assigned with different usage attributes.

5. The information processing apparatus according to claim 4, wherein
the assignment unit manages, in a management table, a file name, a file creation date and time, a logical address, a physical address of each of the semiconductor memories, and the number of reads to be associated with one another, and calculates the read frequency based on the file creation date and time and a value of the number of reads registered in the management table.

6. The information processing apparatus according to claim 5, wherein
the assignment unit is configured
to include, as threshold values for evaluation with respect to the read frequency of the data of the file, at least a first threshold value, a second threshold value, and a third threshold value, which satisfy that the first threshold value<the second threshold value<the third threshold value,
to transfer, to a first semiconductor memory of the plurality of semiconductor memories, the data of the file when the read frequency becomes greater than the third threshold value and the data of the file is in a semiconductor memory other than the first semiconductor memory, the first semiconductor memory being assigned with the usage attribute of the read/write priority,
to transfer, to a second semiconductor memory of the plurality of semiconductor memories, the data of the file when the read frequency becomes greater than the second threshold value and equal to or smaller than the third threshold value, and the data of the file is in a semiconductor memory other than the second semiconductor memory, the second semiconductor memory being assigned with the usage attribute of the read priority,
to transfer, to a third semiconductor memory of the plurality of semiconductor memories, the data of the file when the read frequency becomes greater than the first threshold value and equal to or smaller than the second threshold value, and the data of the file is in a semiconductor memory other than the third semiconductor memory, the third semiconductor memory being assigned with the usage attribute of the write priority, and
to transfer, to a fourth semiconductor memory of the plurality of semiconductor memories, the data of the file when the read frequency is equal to or smaller than the first threshold value, and the data of the file is in a semiconductor memory other than the fourth semiconductor memory, the fourth semiconductor memory being assigned with no usage attribute.

7. The information processing apparatus according to claim 3, wherein
the assignment unit transfers, based on a read frequency of data of a file and an elapsed time from a previous read, the data of the file among the plurality of semiconductor memories which are assigned with different usage attributes.

8. The information processing apparatus according to claim 7, wherein
the assignment unit manages, in a management table, a file name, a file creation date and time, a logical address, a physical address of each of the semiconductor memories, the number of reads, and the latest read time to be associated with one another, and calculates the read frequency and the elapsed time based on the file creation date and time, a value of the number of reads, and the latest read time registered in the management table.

9. The information processing apparatus according to claim 8, wherein
the assignment unit is configured
to include, as threshold values for evaluation with respect to the read frequency of the data of the file, a first read frequency threshold value and a second read frequency threshold value, which satisfy that the first read frequency threshold value>the second read frequency threshold value, and as threshold values for the elapsed time from the previous read, a first elapsed time threshold value and a second elapsed time threshold value, which satisfy that the first elapsed time threshold value<the second elapsed time threshold value,
to transfer, to a semiconductor memory having a higher order than a semiconductor memory storing the data of the file, the data of the file when the read frequency becomes greater than the first read frequency threshold value and the elapsed time is shorter than the first elapsed time threshold value, according to a predetermined order between a first semiconductor memory, a second semiconductor memory, a third semiconductor memory, and a fourth semiconductor memory that are included in the plurality of semiconductor memories, the first semiconductor memory being assigned with the usage attribute of the read/write priority, the second semiconductor memory being assigned with the usage attribute of the read priority, the third semiconductor memory being assigned with the usage attribute of the write priority, the fourth semiconductor memory being assigned with no usage attribute, and
to transfer, to the fourth semiconductor memory, the data of the file when the read frequency is smaller than the second read frequency threshold value and the elapsed time is longer than the second elapsed time threshold value.

10. An information processing method, comprising:
evaluating, by an assignment unit, physical properties of each of a plurality of semiconductor memories constituting one storage device as a whole and assigning a usage attribute corresponding to an evaluation result to at least a part of the plurality of semiconductor memories; and
determining, by a determination unit, a semiconductor memory having an optimal usage attribute as a write destination of data with respect to a write command of the data.
